(19) United States
(12) Patent Application Publication
(10) Pub. No.: US 2014/0297133 A1
(43) Pub. Date: Oct. 2, 2014

(54) AUTOMATIC CHILD LOCK DEVICE

(71) Applicant: Honda elesys Co., Ltd., Yokohama-shi (JP)

(72) Inventor: Hiroshi Oikawa, Yokohama-shi (JP)

(73) Assignee: Honda elesys Co., Ltd., Yokohama-shi (JP)

(21) Appl. No.: 14/227,531

(22) Filed: Mar. 27, 2014

(30) Foreign Application Priority Data
Mar. 28, 2013 (JP) 2013-068716

(51) Int. Cl. E05B 47/00; B60N 2/00

(52) U.S. Cl. CPC E05B 47/0001; B60N 2/002; E05B 2047/0054
USPC 701/45

(57) ABSTRACT

An automatic child lock device includes an electrostatic sensor installed in a seat of a vehicle, for detecting electrostatic capacitance; a detection unit that applies AC voltage to the electrostatic sensor and detects a voltage value from a current generated in the electrostatic sensor in response to the application; an occupant judgment unit that judges that an occupant seated in the seat is a child when the detected voltage value is lower than or equal to a threshold, and judges that the occupant is an adult when the detected voltage value exceeds the threshold; a locking judgment unit that judges whether or not a child lock mechanism installed in a door is in a locked state; and a locking control unit that performs a control to lock the child lock mechanism when the occupant is a child and the child lock mechanism is not in the locked state.

### CROSS-REFERENCE TO RELATED APPLICATION

This application is based upon and claims the benefit of priority of the prior Japanese Patent Application No. 2013-068716, filed on Mar. 28, 2013, the entire contents of which are incorporated herein by reference.

### TECHNICAL FIELD

The present invention relates to an automatic child lock device adapted to automatically lock a door lock of a vehicle for preventing a child from unlocking the door lock.

### BACKGROUND ART

As a conventional automatic child lock device, for example, Patent document 1 describes a technique of judging that a child is seated in a rear seat of a vehicle and automatically locking a door lock (child lock). Moreover, Patent document 1 describes the content of the technique with an example of arranging an electrostatic sensor in the back portion of the seat to distinguish a seating height of the occupant, as an occupant detection sensor for judging whether the occupant is a child or an adult. Furthermore, Patent document 1 describes constituting the occupant detection sensor by using any one of, or combining some of, a load sensor provided in the base portion of the seat, a contact sensor provided in the back portion of the seat, a CCD camera and an image processing device, an infrared sensor and the like.

### PRIOR ART DOCUMENTS

### Patent document

Patent document 1: Japanese Patent Application Publication No. 2009-068265

### SUMMARY OF THE INVENTION

### Problems to be Solved by the Invention

However, in the case of arranging an electrostatic sensor in the back portion of the seat as in the technique of Patent document 1, a plurality of electrostatic sensors need to be arranged at predetermined intervals in the height direction of the seating height in order to distinguish whether the seating height is of a child or an adult. Thus since a plurality of electrostatic sensors are required, a device to distinguish a child from an adult becomes expensive. Consequently, a problem has arisen in that a cost of an automatic child lock device for automatically locking the child lock becomes high.

The present invention has been made in view of the above problems, and it is therefore an object of the present invention to provide an automatic child lock device that can inexpensively realize a configuration to automatically lock a child lock of a vehicle.

### Means for Solving the Problems

In order to solve the above problems, the present invention provides an automatic child lock device including: an electrostatic sensor that is installed in a seat of a vehicle and detects electrostatic capacitance; a detection unit that applies alternating-current voltage to the electrostatic sensor and detects a voltage value from a current generated in the electrostatic sensor in response to application of the alternating-current voltage; an occupant judgment unit that judges that an occupant seated in the seat is a child when the voltage value detected by the detection unit is lower than or equal to a predetermined threshold value, and judges that the occupant is an adult when the voltage value exceeds the predetermined threshold value; a locking judgment unit that judges whether or not a child lock mechanism installed in a door of the vehicle is in a locked state; and a locking control unit that performs a control to lock the child lock mechanism when the occupant judgment unit judges that the occupant is a child and the locking judgment unit judges that the child lock mechanism is not in the locked state.

According to this configuration, with one electrostatic sensor installed in the seat of the vehicle, it is possible to judge whether the occupant is a child or an adult from a difference in magnitude of the electrostatic capacitance according to a difference in impedance, and thus to automatically lock the child lock when the occupant is judged to be a child with small electrostatic capacitance. Namely, since installation of one electrostatic sensor in the seat is sufficient to judge whether the occupant is a child or an adult, the device for the judgment becomes inexpensive. Therefore, cost of the automatic child lock device can be made lower.

### Advantageous Effects of the Invention

The automatic child lock device according to the present invention can inexpensively realize the configuration to automatically lock the child lock of a vehicle.

### BRIEF DESCRIPTION OF THE DRAWINGS

FIG. 1 is a block diagram illustrating a configuration of an automatic child lock device according to an embodiment of the present invention.

FIG. 2 is a schematic diagram showing a door lock mechanism and a child lock mechanism installed in a portion near a rear door in an automobile, and a state in which an occupant is seated in a rear seat.

FIG. 3 is a flowchart for explaining an operation to automatically perform a locking of the child lock by the automatic child lock device according to the present embodiment.

FIG. 4 is a diagram illustrating another configuration of connection between the operational amplifier and the resistor in the automatic child lock device according to the present embodiment.

### EMBODIMENTS OF THE INVENTION

Hereinafter, embodiments of the present invention will be described with reference to the drawings.

### <Configuration of Embodiment>

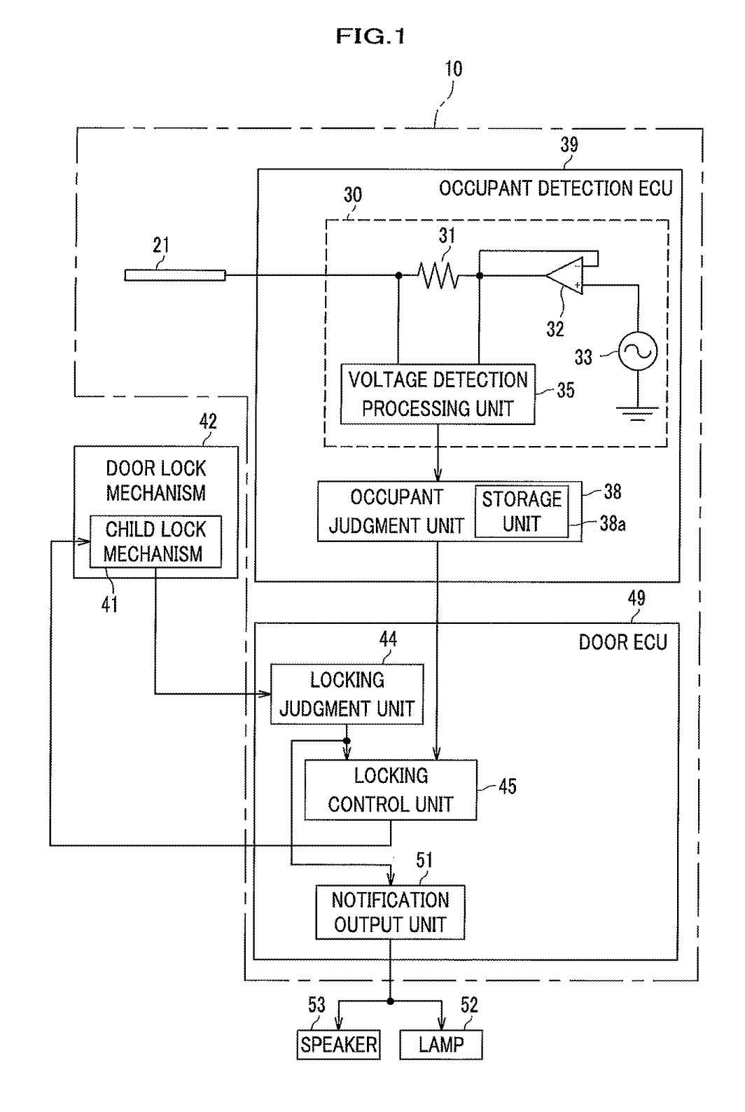

FIG. 1 is a block diagram illustrating a configuration of an automatic child lock device 10 according to an embodiment of the present invention.

The automatic child lock device 10 is adapted to perform a control to automatically lock a child lock in a vehicle, and includes one electrostatic sensor 21, an occupant detection ECU (Electronic Control Unit) 39 that detects an occupant who is seated in a seat in the vehicle, and a door ECU 49 that performs controls for locking and unlocking of the door lock and the child lock in the vehicle.

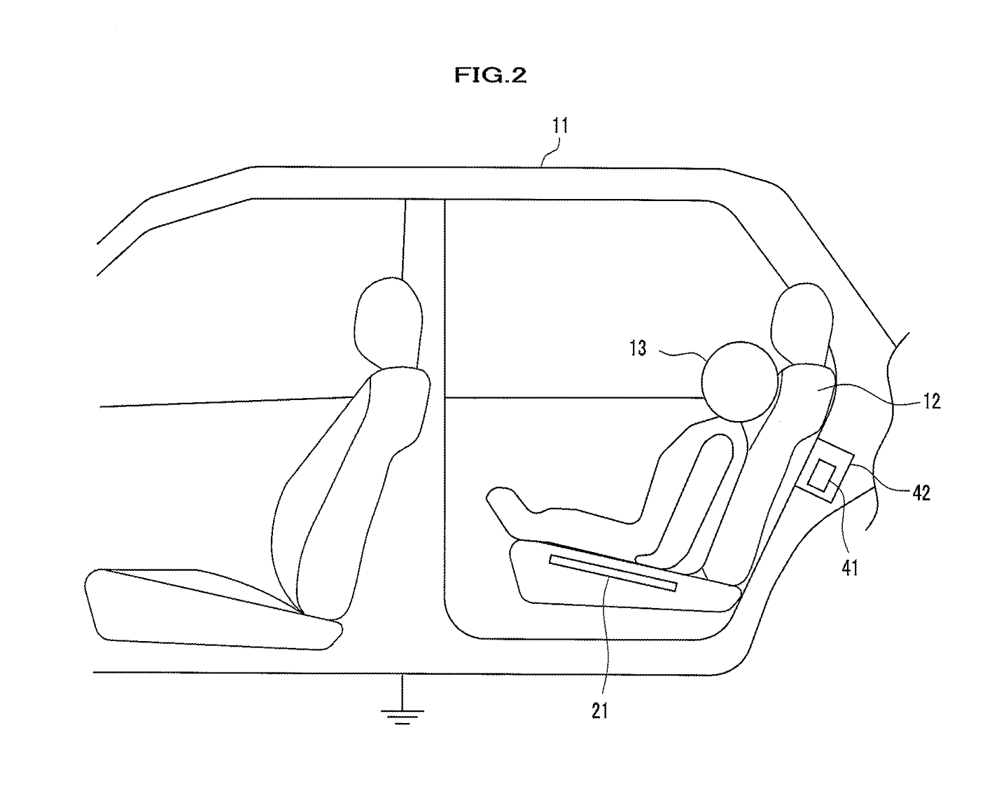

The electrostatic sensor 21 is installed in the base portion of a rear seat (also simply referred to as “seat”) 12 of an automobile (vehicle) 11 as shown in FIG. 2. When the seat 12 is in an unoccupied state, the electrostatic sensor 21 detects an electrostatic capacitance between the electrostatic sensor 21 and a body of the automobile 11. On the other hand, when an occupant 13 is seated as shown in FIG. 2, the electrostatic sensor 21 detects an electrostatic capacitance that is changed due to the occupant 13 intervening between the electrostatic sensor 21 and the body of the automobile 11.

The occupant detection ECU 39 is adapted to detect existence or non-existence of the occupant 13 based on an electrostatic capacitance detected by the electrostatic sensor 21, and includes a detection unit 30 and an occupant judgment unit 38.

The detection unit 30 is adapted to apply alternating-current (AC) voltage to the electrostatic sensor 21 and detect a voltage value from a current generated in the electrostatic sensor 21 in response to application of the AC voltage. The detection unit 30 is constituted with a resistor 31 connected to the electrostatic sensor 21, an operational amplifier 32, an oscillator 33, and a voltage detection processing unit 35.

The oscillator 33 is adapted to oscillate AC voltage (sine wave) which causes the electrostatic sensor 21 to generate a current according to the electrostatic capacitance.

The operational amplifier 32 amplifies the AC voltage oscillated by the oscillator 33 and outputs the amplified voltage to the electrostatic sensor 21 via the resistor 31. The operational amplifier 32 has a non-inverting input end “+” connected to an AC voltage output end of the oscillator 33, and an inverting input end “−” connected to an output end of the operational amplifier 32.

When the occupant 13 is seated in the seat 12 as shown in FIG. 2 in the state in which the AC voltage from the oscillator 33 is amplified by the operational amplifier 32 and then applied to the electrostatic sensor 21, the electrostatic capacitance between the electrostatic sensor 21 and the body of the automobile 11 is changed to be increased according to an impedance of the occupant 13. The electrostatic sensor 21 detects the changed electrostatic capacitance. A current according to the detected electrostatic capacitance causes a voltage difference across both ends of the resistor 31.

Here, the occupant 13 seated in the seat 12 is a child of a specified build, or an adult of a bigger build than the child. Since impedance of the child is lower than that of the adult because of the build of the child being smaller than that of the adult, electrostatic capacitance of the child detected by the electrostatic sensor 21 is smaller than that of the adult, resulting in a smaller voltage difference across both ends of the resistor 31. Note that, using a predetermined impedance value as a threshold value, a judgment of whether the occupant 13 is a child or an adult is made based on the threshold value.

The voltage detection processing unit 35 is adapted to detect an electrostatic capacitance detected by the electrostatic sensor 21, as a voltage value. The voltage detection processing unit 35 detects a current value from the voltage difference generated across both ends of the resistor 31 and converts the current value into voltage to detect a voltage value. Namely, the electrostatic capacitance detected by the electrostatic sensor 21 is detected as the voltage value.

The occupant judgment unit 38 is adapted to judge from the voltage value detected by the voltage detection processing unit 35, whether the occupant 13 seated in the seat 12 is a child or an adult. The occupant judgment unit 38 includes a storage unit 38a which stores the threshold value for use in distinguishing whether the occupant 13 seated in the seat 12 is a child or an adult. The occupant judgment unit 38 judges that the occupant 13 is an adult when the voltage value detected by the voltage detection processing unit 35 exceeds the threshold value, and judges that the occupant 13 is a child when the voltage value is lower than or equal to the threshold value.

The door ECU 49 includes a child lock locking judgment unit (also simply referred to as “locking judgment unit”) 44, a child lock locking control unit (also simply referred to as “locking control unit”) 45, and a notification output unit 51.

The locking judgment unit 44 is adapted to judge whether or not the child lock is locked. The locking judgment unit 44 is connected to a signal line for transmitting a locking signal or an unlocking signal which indicates that a child lock mechanism 41 provided in a door lock mechanism 42 is locked or unlocked, and judges in response to the locking signal or the unlocking signal, whether or not the child lock mechanism 41 is locked. As shown in FIG. 2, the door lock mechanism 42 is provided in the portion near the rear door on the side of the rear seat 12, while the child lock mechanism 41 is installed in the door lock mechanism 42.

The child lock mechanism 41 is provided with a release lever (not shown) for enabling or disabling the child lock function, besides a door lock knob generally provided inside of the rear door. The child lock mechanism 41 is adapted to mechanically disable, with an operation of the release lever, both an unlocking operation with the door lock knob and a door opening operation with an inner handle of the rear door, thereby making it impossible to open the rear door except for an operation of an outer handle outside of the rear door. Note that, the child lock mechanism 41 outputs the locking signal to the door ECU 49 when it is in the locked state, and outputs the unlocking signal to the door ECU 49 when it is in the unlocked state.

As shown in FIG. 1, the locking control unit 45 is adapted to execute a control to automatically perform a locking of the child lock. More specifically, the locking control unit 45 executes a control to automatically perform a locking of the child lock in the child lock mechanism 41 when the locking judgment unit 44 judges that the child lock mechanism 41 is not locked and the occupant judgment unit 38 judges that the occupant 13 is a child.

The notification output unit 51 is adapted, when the locking of the child lock is performed, to notify that the locking is performed, so as to be perceivable by a person. The notification output unit 51 is connected to a lamp (notifying means) 52 and a speaker (notifying means) 53 which are installed on a front panel (not shown) or the like in the automobile 11 (see FIG. 2). When the locking judgment unit 44 judges that the child lock mechanism 41 is locked, the locking signal is inputted to the notification output unit 51, which in turn outputs a notification signal to the lamp 52 and the speaker 53, thereby causing the lamp 52 to light or blink and the speaker 53 to generate a buzzer or alarm sound, so as to be perceivable by a person. The notification output unit 51 may cause the speaker 53 to make an announcement indicating that the child lock has been locked, by means of a human voice. Note that, any one of the lamp 52 or the speaker 53 may be provided to perform the corresponding operation.

### <Operation of Embodiment>

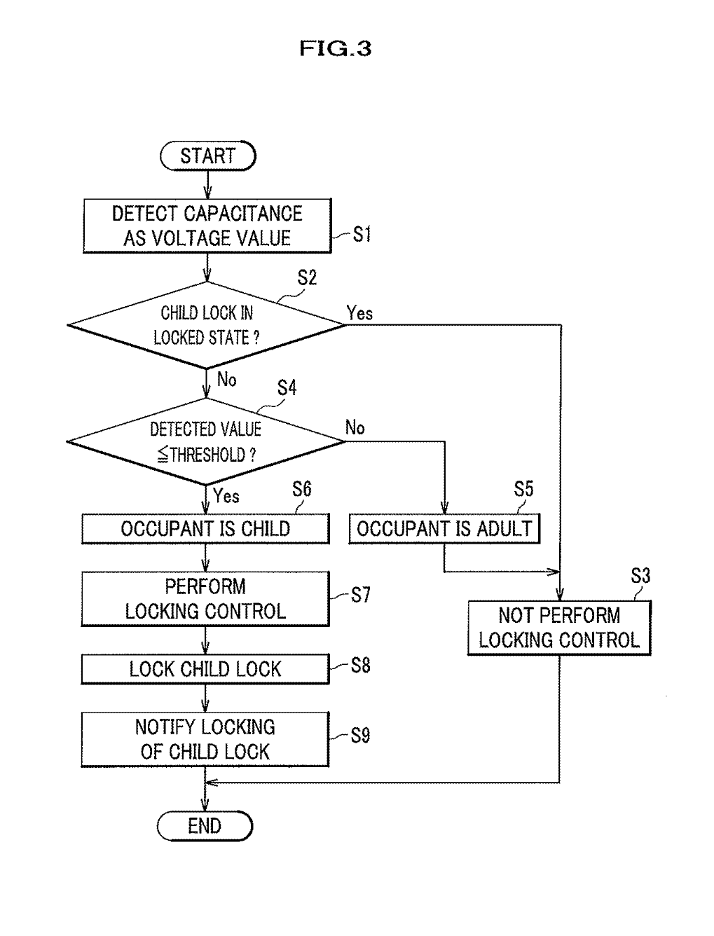

Next, an operation to automatically perform a locking of the child lock by the automatic child lock device 10 will be described with reference to the flowchart shown in FIG. 3.

In step S1, when the occupant 13 is seated in the seat 12 as shown in FIG. 2, electrostatic capacitance detected by the electrostatic sensor 21 is detected by the detection unit 30 as a voltage value. More specifically, an AC voltage outputted from the oscillator 33 is amplified by the operational amplifier 32 and then the amplified voltage is applied via the resistor 31 to the electrostatic sensor 21. In response to application of the AC voltage, a current is generated in the electrostatic sensor 21, and the current causes a voltage difference across both ends of the resistor 31. Further, the voltage detection processing unit 35 detects a current value from the voltage difference and converts the current value into voltage to detect as a voltage value.

Next, in step S2, the locking judgment unit 44 judges whether or not the child lock mechanism 41 is in the locked state, in response to the locking signal or the unlocking signal from the child lock mechanism 41.

As a result, when the child lock mechanism 41 is judged to be in the locked state (Yes), in step S3, the locking control unit 45 does not perform the locking control over the child lock function of the child lock mechanism 41 (not yet executed).

On the other hand, as a result of the judgment in the above step S2, when the child lock mechanism 41 is judged to be not in the locked state (No), the occupant judgment unit 38 judges in step S4, whether or not the voltage value detected in the above step S1 is lower than or equal to the threshold value stored in the storage unit 38a.

When a result of the judgment is No, i.e., when the detected voltage value is judged to exceed the threshold value, in step S5, the occupant judgment unit 38 judges that the occupant 13 is an adult.

In this case, in step S3, the locking control unit 45 does not perform the locking control over the child lock function of the child lock mechanism 41.

On the other hand, when a result of the judgment in the above step S4 is Yes, i.e., when the detected voltage value is judged to be lower than or equal to the threshold value, in step S6, the occupant judgment unit 38 judges that the occupant 13 is a child. In this case, in step S7, the locking control unit 45 performs the locking control for the child lock mechanism 41. By the locking control, in step S8, the child lock of the child lock mechanism 41 is automatically locked.

In step S9, the locking of the child lock is judged by the locking judgment unit 44 and the notification output unit 51 receives the locking signal based on the judgment of the locking from the locking judgment unit 44, and causes the lamp 52 to light or blink so as to be perceivable by a person. At the same time, the notification output unit 51 causes the speaker 53 to generate a buzzer or alarm sound for notification, so as to be perceivable by a person. Alternatively, the notification output unit 51 may cause the speaker 53 to make an announcement indicating that the child lock is locked, by means of a human voice.

### <Advantageous Effects of Embodiment>

As described above, the automatic child lock device 10 according to the present embodiment is configured to include the electrostatic sensor 21, the detection unit 30, the occupant judgment unit 38, the locking judgment unit 44 and the locking control unit 45. Accordingly, with one electrostatic sensor 21 installed only in the base portion of the seat 12 of the automobile 11, it is possible to judge whether the occupant 13 is a child or an adult and then to automatically lock the child lock when the occupant 13 is judged to be a child.

According to the configuration of the present embodiment, since installation of one electrostatic sensor 21 in the seat 12 is sufficient to judge whether the occupant 13 is a child or an adult, the device for the judgment becomes inexpensive. Therefore, the cost of the automatic child lock device 10 can be made lower.

Moreover, the automatic child lock device 10 further includes the notification output unit 51 for notifying, when the locking judgment unit 44 judges that the child lock mechanism 41 is in the locked state, that the child lock mechanism 41 is in the locked state, so as to be perceivable by a person.

This configuration allows a person such as a driver to perceive that the child lock mechanism 41 has been locked.

In addition, in the case of the child lock mechanism 41 being in the unlocked state, the notification output unit 51 may notify that the child lock mechanism 41 is the unlocked state, so as to be perceivable by a person. In this case, for example, the lamp 52 may light in red so as to allow the person to perceive that the child lock mechanism 41 is in the unlocked state. Then, when the child lock mechanism 41 is changed to the locked state, the lamp 52 may light in green.

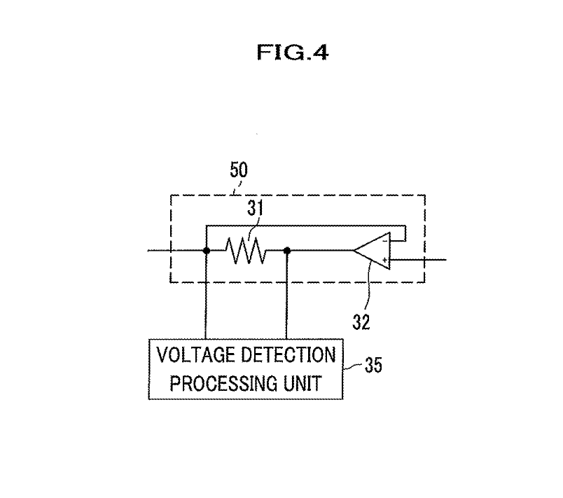

Note that, as for the connection of the operational amplifier 32 with the resistor 31 in FIG. 1, one end of the resistor 31 is connected to the output end of the operational amplifier 32, and the one end of the resistor 31 and the inverting input end “−” of the operational amplifier 32 are connected to each other. However, this connection maybe modified such as shown in a frame 50 indicated by a broken line in FIG. 4.

More specifically, the one end of the resistor 31 is connected to the output end of the operational amplifier 32, and the other end on the opposite side to the one end of the resistor 31 and the inverting input end “−” of the operational amplifier 32 may be connected to each other.

### REFERENCE SIGNS LIST

10 Automatic child lock device
11 Automobile
12 Rear seat (Seat)
13 Occupant
21 Electrostatic sensor
30, 50 Detection unit
31 Resistor
32 Operational amplifier
33 Oscillator
35 Voltage detection processing unit
38 Occupant judgment unit
38a Storage unit
39 Occupant detection ECU
41 Child lock mechanism
42 Door lock mechanism
44 Child lock locking judgment unit
45 Child lock locking control unit
49 Door ECU
51 Notification output unit
52 Lamp (Notifying means)
53 Speaker (Notifying means)

What is claimed is:

1. An automatic child lock device comprising:
an electrostatic sensor that is installed in a seat of a vehicle and detects electrostatic capacitance;
a detection unit that applies alternating-current voltage to the electrostatic sensor and detects a voltage value from a current generated in the electrostatic sensor in response to application of the alternating-current voltage;
an occupant judgment unit that judges that an occupant seated in the seat is a child when the voltage value detected by the detection unit is lower than or equal to a predetermined threshold value, and judges that the occupant is an adult when the voltage value exceeds the predetermined threshold value;
a locking judgment unit that judges whether or not a child lock mechanism installed in a door of the vehicle is in a locked state; and
a locking control unit that performs a control to lock the child lock mechanism when the occupant judgment unit judges that the occupant is a child and the locking judgment unit judges that the child lock mechanism is not in the locked state.

2. The automatic child lock device according to claim 1, further comprising a notification output unit that outputs, when the locking judgment unit judges that the child lock mechanism is in the locked state, a notification signal to a notifying means for notifying so as to be perceivable by a person that the child lock mechanism is in the locked state.
